(19) United States
(12) Patent Application Publication
(10) Pub. No.: US 2016/0091154 A1
(43) Pub. Date: Mar. 31, 2016

(54) CHRISTMAS LIGHT STRINGS WITH IDENTIFICATION OF BULB CURRENT RATING OR LED COLOR

(71) Applicant: JLJ, Inc., Bellbrook, OH (US)

(72) Inventor: John L. Janning, Bellbrook, OH (US)

(21) Appl. No.: 14/524,619

(22) Filed: Oct. 27, 2014

Related U.S. Application Data
(60) Provisional application No. 62/071,696, filed on Sep. 30, 2014.

(51) Int. Cl. F21S 4/00; H01R 33/09; H01R 13/46

(52) U.S. Cl. CPC F21S 4/001; H01R 13/465; H01R 33/09; F21W 2121/04

(57) ABSTRACT

A series wired light string which includes a marking on the bulb holder or socket of each light with the identity, i.e., current rating, of the bulb, or in the case of an LED light string, the color of the LED, for replacement purposes. The identity marking can be applied to either or both of the bulb/LED socket and holder, and can be added to the socket during molding or afterwards by other means.

This application claims priority to U.S. Provisional Application No. 62/071,696, filed Sep. 30, 2014, the disclosure of which is herein incorporated by reference.

### BACKGROUND OF THE INVENTION

1. Field of the Invention

The present invention relates to series wired light strings, such as used in Christmas decorative lighting and, more particularly, to an identity marking to facilitate the replacement of defective lights in the series-wired light string.

2. Description of the Related Art

Consumers of light strings are often frustrated in finding replacement lights (bulbs or LEDs) for Christmas light strings in which one or more lights are burned out or otherwise defective. The main problem for the consumer is determining the proper type of light bulb or LED for replacement—i.e., a bulb with the correct current rating or an LED of the correct color.

Not too long ago, there was only one type of bulb: a 2.5 volt incandescent bulb used in a 50 or 100-light string—it drew a current of 170 milliamperes (170 mA). Today, Christmas light strings use light bulbs with a variety of current ratings—85 mA; 100 mA; 135 mA; 170 mA; 200 mA—just to name a few. All are rated at 2.5 volts.

LEDs in various colors are also becoming increasingly popular for use in Christmas light strings. Each color LED operates at 20 mA, but the voltage drop across the LED varies according to the color of the LED. For example, a red LED only requires about 2 volts for illumination, while a blue LED requires about 3.4 volts.

As will be apparent to those skilled in the art, it is important, for safety reasons and for proper illumination of the light string, that replacement bulbs inserted by consumers have the correct current rating and that replacement LEDs are the correct color.

Accordingly, it would be desirable to provide, on the light string, an indication to the user of the current rating of the bulb or the color of the LED to use as a replacement for a burned out or missing bulb or LED.

### SUMMARY OF THE INVENTION

The present invention provides an elegant but simple solution to the aforementioned replacement identity problem by providing a marking on the bulb holder or socket with the identity of the bulb or LED, specifying the current rating of the replacement bulb or the color of the replacement LED. The identity marking can be applied to the bulb/LED holder or socket during molding or afterwards by other means.

Other advantages, variations and other features of the invention will become apparent from the drawings, the further description of examples and the claims to follow.

### BRIEF DESCRIPTION OF THE DRAWINGS

FIG. 1 illustrates the identity printed on the bulb socket.

FIG. 2 illustrates the identity printed on the bulb holder.

FIG. 3 shows that the identity can include both the voltage and current of the bulb, printed on opposite sides of the bulb holder.

FIG. 4 illustrates the identification of the color of the LED printed on the LED socket and the LED holder.

### DETAILED DESCRIPTION OF THE PREFERRED EMBODIMENTS

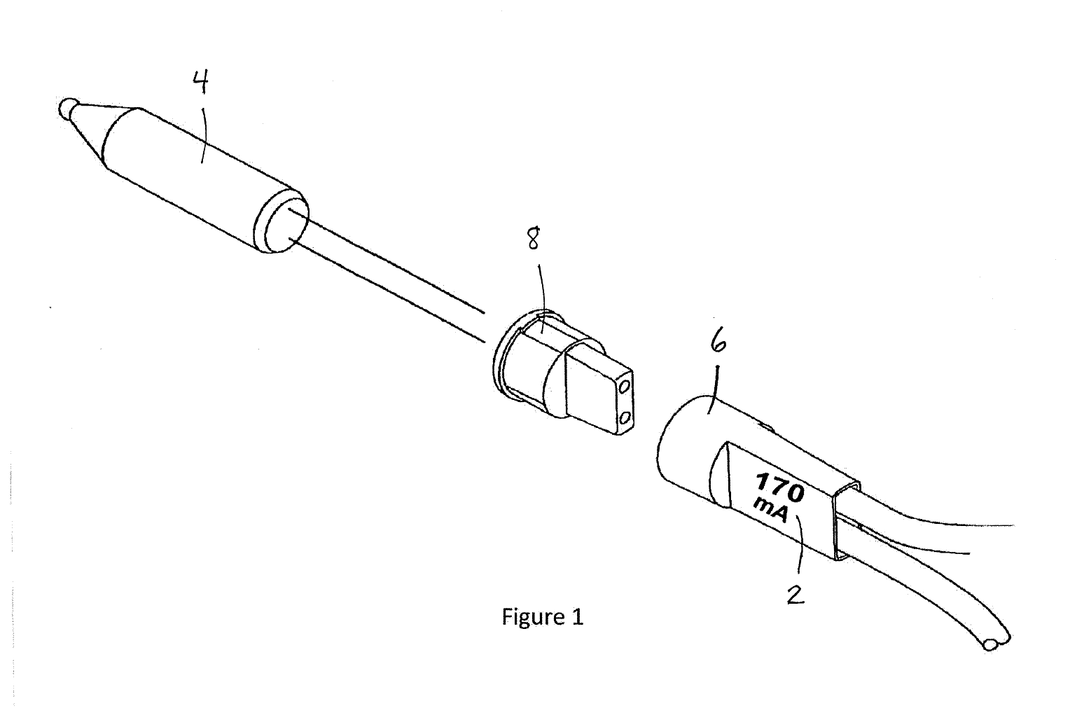

Referring now to the drawings, FIG. 1 shows an embodiment of the present invention in which the indicator 2 of the current rating of the bulb 4 is provided on the bulb socket 6. The current rating shown in FIG. 1 is 170 mA only as an example. The indication of the current rating can be applied to the socket in any of a number of ways. For example, the numbers/characters can be raised in the molding or indented or recessed. If not molded, the characters/numbers of the bulb current rating can simply be printed onto the socket.

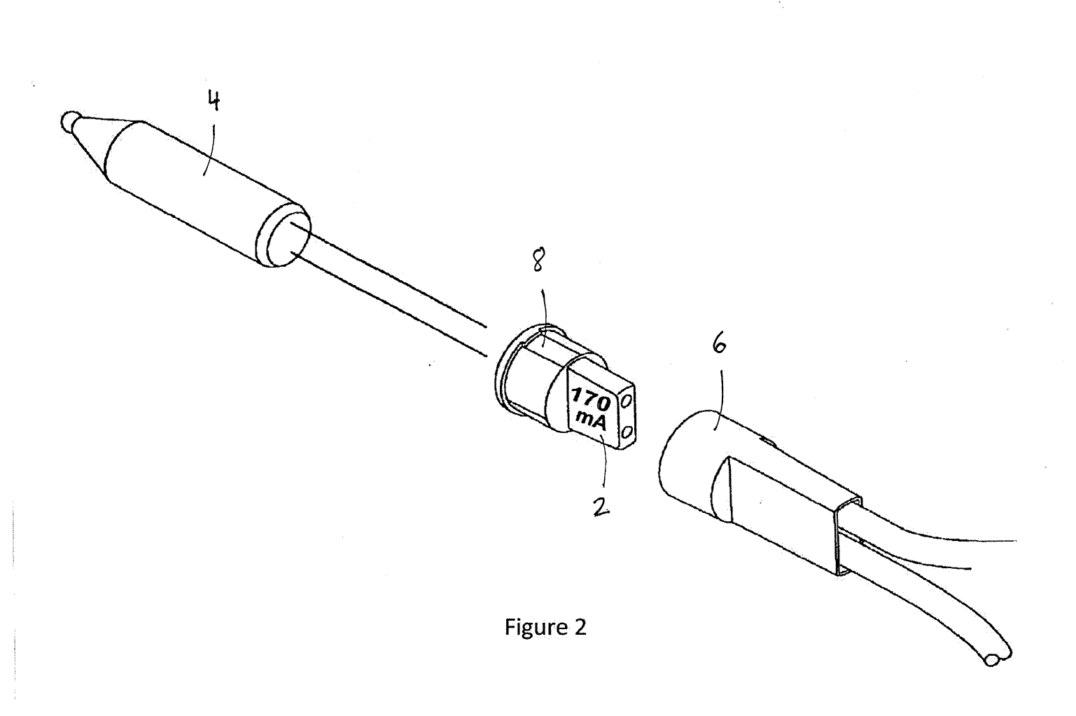

As shown in FIG. 2, the replacement bulb indicator 2 can alternatively (or in addition) be provided on the bulb holder 8. Again, the numbers/characters of the current rating can be raised/recessed in the bulb holder molding or simply printed onto the bulb holder 8.

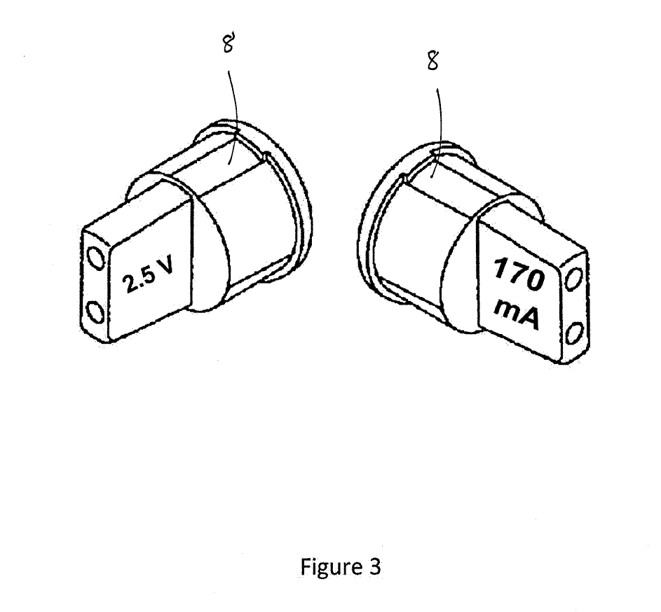

If desired, indicators of both the current rating and the voltage rating of the bulb can be provided, preferably on opposite sides of the bulb holder 8, as shown in FIG. 3, and/or on opposite sides of the bulb socket (not shown).

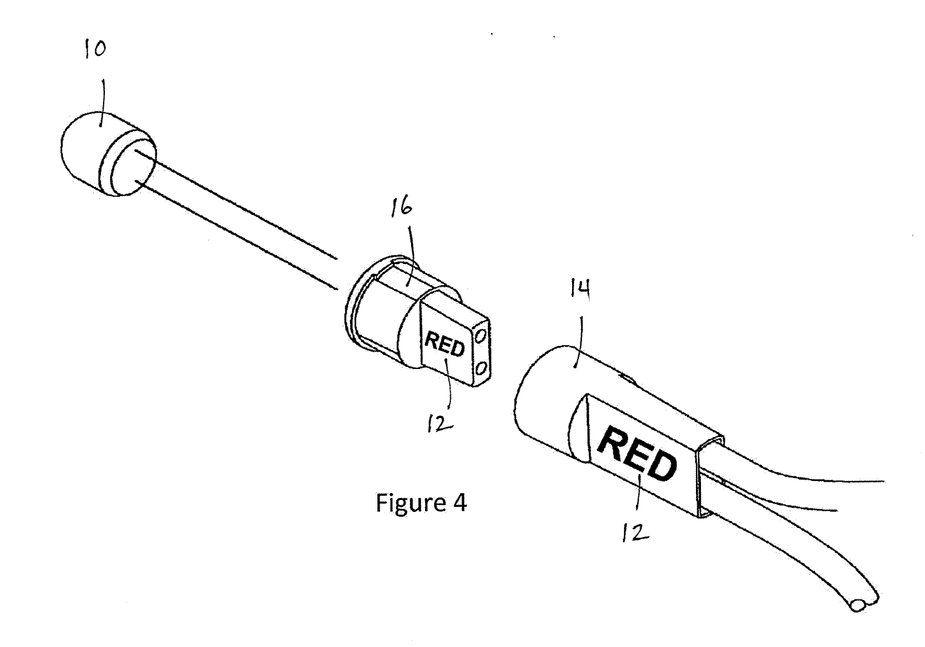

FIG. 4 shows an embodiment of the present invention for identifying the color of an LED 10 in an LED light string. The color of the LED is identified in lettering 12 (possibly colored itself) on the LED socket 14 and/or the LED holder 16. It is important for the consumer to replace an inoperative LED with a replacement LED of the same color to ensure proper voltage drop across the string.

The present invention advantageously simplifies the replacement of defective bulbs or LEDs in a series-wired light string, by providing consumers with an identification of the current rating of the bulb to be replaced, or the color of the inoperative LED to be replaced. The present invention thus increases the safety of bulb/LED replacement by consumers.

Although the invention has been described in detail in connection with the exemplary embodiments, it should be understood that the invention is not limited to the above disclosed embodiments. Rather, the invention can be modified to incorporate any number of variations, alternations, substitutions, or equivalent arrangements not heretofore described, but which are commensurate with the spirit and scope of the invention. Accordingly, the invention is not limited by the foregoing description or drawings, but is only limited by the scope of the appended claims.

1-3. (canceled)

4. A Christmas light string comprising a plurality of light units connected in electrical series, each unit comprising a bulb socket, a bulb holder and a light bulb, wherein the bulb holder includes an identification of the current rating of the light bulb of the unit for replacement purposes.

5. An Christmas LED string comprising a plurality of LED light units connected in electrical series, each LED light unit comprising an LED socket, an LED holder and an LED, wherein the LED holder includes an identification in lettering of the color of the LED of the LED light unit for replacement purposes.
